(19) United States
(12) Patent Application Publication
(10) Pub. No.: US 2026/0332430 A1
(43) Pub. Date: Oct. 22, 2026

(54) SEQUENCE-BASED SQUARE ROOT COMPUTATIONS AND PRIMALITY TESTING IN CRYPTOGRAPHIC APPLICATIONS

(71) Applicant: Cryptography Research, Inc., San Jose, CA (US)

(72) Inventors: Michael Alexander Hamburg, Rosmalen (NL); Qinglai Xiao, Espoo (FI)

(21) Appl. No.: 19/635,422

(22) Filed: Mar. 31, 2026

Related U.S. Application Data
(60) Provisional application No. 63/783,039, filed on Apr. 3, 2025.
(60) Provisional application No. 63/890,621, filed on Sep. 30, 2025.

(51) Int. Cl. H04L 9/32

(52) U.S. Cl. CPC H04L 9/3247

(57) ABSTRACT

Disclosed aspects and implementations are directed to systems and techniques for efficient use of number sequences in computations of square roots and primality testing in cryptographic applications. The disclosed techniques include processing an input into a cryptographic operation to obtain an input into a square root computational operation and performing a plurality of iterations of a number sequence associated with a first value and a second value, the first value initiated using the input into the square root computational operation. An individual iteration includes updating the first value or the second value based on both values, detecting that one of the values is zero, determining an output of the square root computational operation based on another one of the second value or the first value, and computing, using the output of the square root computational operation, an output of the cryptographic operation.

### CLAIM OF PRIORITY

The present application claims the benefit under 35 U.S.C. § 119(e) of U.S. Provisional Patent Application No. 63/890,621 filed Sep. 30, 2025 and U.S. Provisional Patent Application No. 63/783,039, filed Apr. 3, 2025, the contents of both applications being incorporated in their entirety by reference herein.

### TECHNICAL FIELD

Aspects of the present disclosure are directed to cryptographic computing applications, more specifically to fast and efficient implementation of frequently used cryptographic computations, including but not limited to square root computations and prime number testing.

### BRIEF DESCRIPTION OF THE DRAWINGS

The present disclosure will be understood more fully from the detailed description given below and from the accompanying drawings of various implementations of the disclosure.

FIG. 1A illustrates an example computing architecture that supports Lucas number sequence (NS)-based operations in cryptographic applications, in accordance with one or more aspects of the present disclosure.

FIG. 1B illustrates another example computing architecture that supports Lucas NS-based operations in cryptographic applications, in accordance with one or more aspects of the present disclosure.

FIG. 2 illustrates schematically a flowchart of example operations that use Lucas number sequences in computations of square roots in cryptographic applications, in accordance with one or more aspects of the present disclosure.

FIG. 3 illustrates schematically a flowchart of example operations of using a Lucas number sequence for primality testing in cryptographic applications, in accordance with one or more aspects of the present disclosure.

FIG. 4 is a block diagram illustrating an example computing platform capable of supporting Lucas NS-based computations of square roots and Lucas NS-based primality testing in cryptographic applications, in accordance with one or more aspects of the present disclosure.

FIG. 5 depicts a flow diagram of an example method of using Lucas number sequences in computations of square roots in cryptographic applications, in accordance with one or more aspects of the present disclosure.

FIG. 6 depicts a flow diagram of an example method of using Lucas number sequences in primality testing in cryptographic applications, in accordance with one or more aspects of the present disclosure.

FIG. 7 depicts a block diagram of an example computer system operating in accordance with one or more aspects of the present disclosure.

### DETAILED DESCRIPTION

In public-key cryptography systems, a processing device may have various components/modules used for cryptographic operations on input messages, which are typically represented via large integers. Cryptographic algorithms often involve modular arithmetic operations with modulus q, in which the set of all integers Z is wrapped around a circle of length q (the set Z_{q}), so that any two numbers that differ by q (or any other integer multiple of q) are congruent to (and treated as) the same number within Z_{q}. Cryptographic applications—such as the Rivest-Shamir-Adelman (RSA) algorithm, digital signature algorithms (DSA), Diffie-Hellman key exchange (DHKE) algorithms, Elliptic Curve Cryptography (ECC) algorithms, and the like—exploit the fact that solving an integer factorization problem, a discrete logarithm problem, an elliptic curve discrete logarithm problem, and/or the like, involves prohibitively difficult operations (for large moduli q) on a classical computer.

ECC algorithms involve operations with points on an elliptic curve. For example, an elliptic curve f(x, y)=0 may be a Weierstrass curve where f(x, y) is a third-degree polynomial in x and a second-degree polynomial in y, e.g. f(x, y)=x³−y²+ax+b. Various values (e.g., public and private data) may be associated with points P ≡(x, y) on such elliptic curves and a set of specific arithmetic rules may be defined for point doubling (squaring), 2P, point addition (multiplication) P+Q, zero (infinity) point, and so on. The strength of the elliptic curve cryptography is rooted in the fact that for a large number of additions/doublings involving private data, an output can be practically anywhere on the elliptic curve, such that inverse operations to determine a secret input (e.g., private key) from a known (public) output are prohibitively difficult.

Elliptic curve cryptographic applications often involve square root computations y=\sqrt{X} in a finite field [symbol] _{q} of order q, which may be a prime number q=p. For example, a point on an elliptic curve may be specified (e.g., in storage) by the point's x coordinate while the y coordinate is computed on the fly, e.g., as y=±\sqrt{x³+ax+b}. Additionally, square root operations may be performed as part of operations used to convert (map) a hash output to a point on the curve. Computations of square roots in finite fields [symbol] ₚ may be performed using various existing algorithms. For example, the Legendre method may be used when p−1 is a multiple of 2 but not a multiple of 4. The Atkin method may be used when p−1 is a multiple of 4 but not a multiple 8. Such methods work in many applications but are less useful in applications where p−1 is divisible by many powers of 2, e.g., in the NIST secp224r1 elliptic curve, in which p−1=2²²⁴−2⁹⁶, is divisible by k=96 powers of 2.

Several algorithms that can be used in such cases, e.g., Tonelli-Shanks square root algorithm, are slow with the number of operations (multiplications) scaling as O(k²). Other algorithms, e.g., the Müller's algorithm, may operate somewhat faster for p−1=2²²⁴−2⁹⁶ than the Tonelli-Shanks algorithm. However, a single iteration of the Mller's algorithm is successful in only 50% of the time, resulting in a relatively low yield of the method and requiring multiple attempts to compute \sqrt{X}. The Pocklington-Peralta algorithm is more reliable than the Tonelli-Shanks algorithm (having a negligible frequency of failures) but is significantly slower than the Müller algorithm. Kim-Koo-Kwon algorithm (Bulletin of the Korean Mathematical Society 59.6, p. 1523 (2022) has improved the Pocklington-Peralta algorithm by replacing exponentiation with Lucas sequence computations.

Aspects and implementations of the instant disclosure address these and other challenges of the cryptographic technology by providing for systems and techniques that speed up square root computations in ECC and other cryptographic applications using iterative number sequences, e.g., Lucas number sequences. Target square root values \sqrt{X} occur as side products of such number sequences arising in association with square roots \sqrt{D} of discriminants D of characteristic equations of such sequences. The Lucas sequence V₀, V₁, V₂, . . . Vₙ, is defined by the recurrence equation, Vₙ₊₁=PVₙ, −QVₙ₋₁, with some parameters P and Q. The Lucas sequence is a generalization of the Fibonacci sequence Fₙ₊₁=Fₙ+Fₙ₋₁(where P=1 and Q=−1). Similarly to the Fibonacci sequence, whose characteristic equation is associated with the Golden Ratio and the corresponding discriminant D=5 (and can, therefore, be used for computing \sqrt{5}), the generalized Lucas sequence is associated with the discriminant D=P²−4Q and may, therefore, be used to compute \sqrt{X}, provided that the values P and/or Q are selected in such a way that the discriminant P²−4Q is proportional to (or otherwise revealing) X.

The advantages of the disclosed techniques include (but are not limited to) fast and efficient computation of square roots that has a high probability of being successful in computing a square root after a single iteration of the Lucas number sequence. Additionally, as disclosed in more detail below, the Lucas number sequences may be used for efficient primality testing.

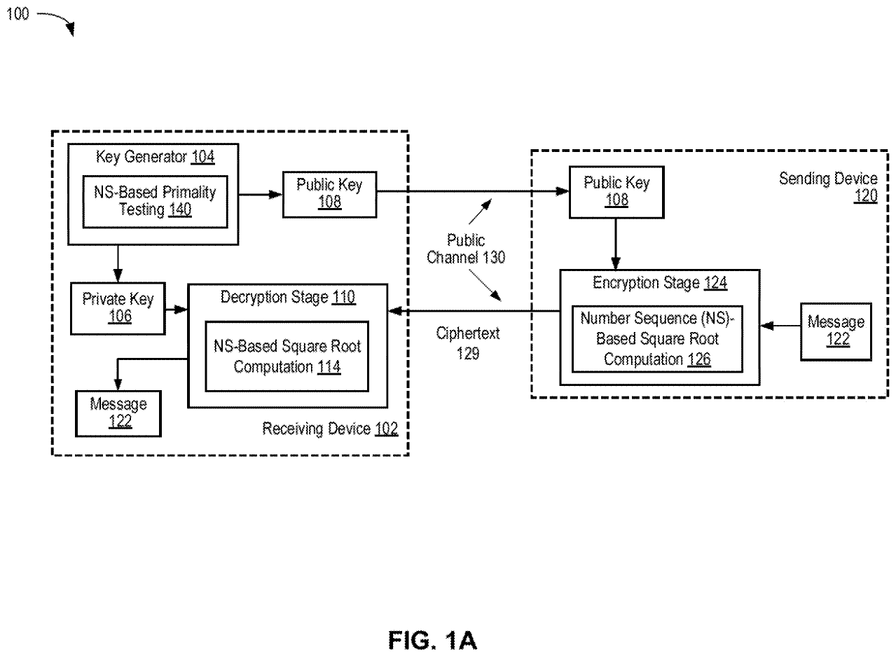

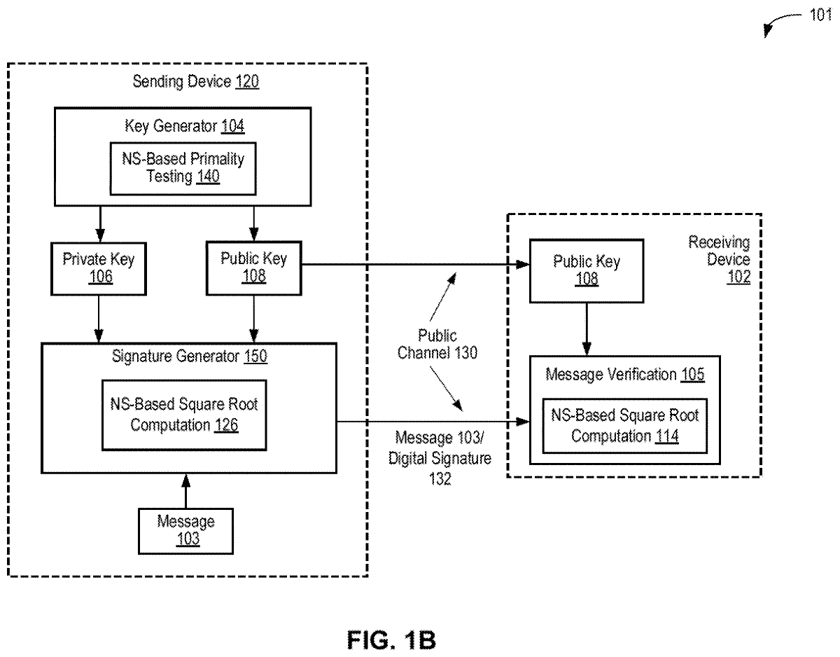

FIG. 1A illustrates an example computing architecture 100 that supports Lucas number sequence (NS)-based operations in cryptographic applications, in accordance with one or more aspects of the present disclosure. In some implementations, computing architecture 100 implements public/private key cryptographic applications, elliptic curve cryptographic applications, key encapsulation applications, and/or other cryptographic applications. Computing architecture 100 may include various components/modules/applications that are not explicitly depicted in FIG. 1A, including but not limited to various domain-specific applications that perform operations on output or input messages. Computing architecture 100 may include a receiving device 102 deploying a cryptographic application-specific key generator 104 that may generate a private key 106 and a public key 108. Receiving device 102 may provide public key 108 to a sending device 120 that uses public key 108 to encrypt a message 122 before sending ciphertext (encrypted message) 129 over a public communication channel 130, which may include any network, e.g., Internet, local area network, wide area network, and/or the like. In some implementations, message 122 may encapsulate a symmetric key provided to receiving device 102 to establish secure communication between receiving device 102 and sending device 120 over a public communication channel 130. Message 122 may be encrypted by an encryption stage 124 implementing a suitable encryption scheme. In some implementations, the encryption scheme may be one of the post-quantum encryption schemes, including but not limited to Kyber, and/or other similar algorithms.

Encryption stage 124 may include an NS-based square root computation module 126 that represents an input value X via parameters P and Q of a Lucas number sequence and runs multiple iterations of the Lucas number sequence until the square root V is computed (which may include running multiple Lucas number sequences) or until it is determined that the square root V does not exist.

Receiving device 102 may process the received ciphertext 129 using decryption stage 110 and recover message 122 using private key 106. Decryption stage 110 may also include an NS-based square root computation 114 that operates similar to the NS-based square root computation 126 of the encryption stage 124 to compute square roots as part of cryptographic computations. Although, for illustration, ciphertext(s) and plaintext(s) (decrypted messages) are generated/processed by different devices in the illustration of FIG. 1A, in some instances ciphertext(s) and plaintext(s) may be generated/processed by the same device. For example, sending device 120 may be the same device as receiving device 102.

In some implementations, receiving device 102 may perform primality testing as disclosed in more detail below. For example, NS-based primality testing 140 may be implemented as part of key generator 104. NS-based primality testing 140 may run any number of primality tests, including but not limited to Fermat tests, Euler tests, Baillie-Pomerance-Selfridge-Wagstaff (Baillie-PSW) tests, Lucas tests, Miller-Rabin tests, Baillie-Fiori-Wagstaff tests, and/or any combinations thereof. In some implementations, NS-based primality testing 140 may initiate a Lucas number sequence with parameters P and Q defined for a specific candidate number N and run one or more iterations of the Lucas number sequence as part of the determination whether number N is a prime number or a composite number.

Various other cryptographic operations may be performed by receiving device 102 and/or sending device 120 that are not shown in FIG. 1A, including but not limited to masking (obfuscation) of secret data against side-channel attacks, computing hash values, generating shared secret keys, session keys, ephemeral keys, storing secret and public data, fetching secret and/or public data, performing error correction, and/or any other suitable data processing operations.

FIG. 1B illustrates another example computing architecture 101 that supports NS-based operations in cryptographic applications, in accordance with one or more aspects of the present disclosure. Computing architecture 101 may implement message authentication using digital signature algorithms, and/or other cryptographic applications. As illustrated in FIG. 1B, sending device 120 may deploy key generator 104 that generates private key 106 and public key 108. Sending device 120 may provide public key 108 to receiving device 102. Key generator 104 may include NS-based primality testing 140 operating as described in conjunction with FIG. 1A. Sending device 120 may include a signature generator 150 that authenticates message 103 using private key 106 or a combination of private key 106 and public key 108. In some implementations, signature generator 150 may also include NS-based square root computation 126 to optimize elliptic curve cryptographic operations and/or any other suitable operations. In some implementations, the digital signature scheme may be one of the post-quantum digital signature schemes.

Sending device 120 may send message 103 together with digital signature 132 produced by signature generator 150 to receiving device 102 over public communication channel 130. Receiving device 102 may use public key 108 to perform message verification 105 to verify digital signature 132. In some implementations, operations of message verification 105 may use NS-based square root computation 114. Although, in the illustration of FIG. 1B different devices perform signature generation and signature verification, in some instances both algorithms may be performed by the same device (e.g., with sending device 120 being the same as receiving device 102).

Although FIG. 1A and FIG. 1B illustrate various blocks and components that perform operations of the instant disclosure, various additional blocks and components may perform any other suitable cryptographic operations, e.g., masking, splitting into shares, hashing, using Number Theoretic Transforms, Fast Fourier Transforms, and/or any other suitable operations to protect secret data generated, fetched, received, stored, communicated, and/or the like, in conjunction with any suitable cryptographic algorithms that may be deployed on receiving device 102 and/or sending device 120.

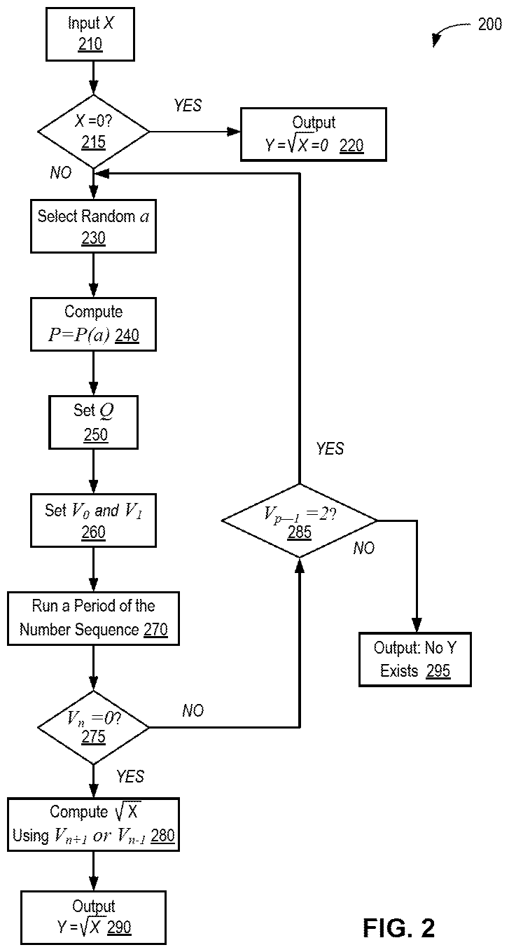

FIG. 2 illustrates schematically a flowchart of example operations 200 that use Lucas number sequences in computations of square roots in cryptographic applications, in accordance with one or more aspects of the present disclosure. Operations 200 can be performed as part of encryption, decryption, and/or authentication of any suitable message by a cryptographic application, e.g., by NS-based square root computation 114 and/or 126, with reference to FIG. 1A and FIG. 1B. Operations 200 may be performed to process an input value X and output a square root of the input value, Y=\sqrt{X}, which may be a value in any suitable finite field [symbol] ₚ (or extension field). Operations 200 may deploy a Lucas sequence V₀, V₁, V₂, . . . Vₙ defined by the recurrence equation,

$${V}_{n + 1} = {PV}_{n} - {QV}_{n - 1} ,$$

with suitably chosen parameters P and Q. As follows from the direct substitution, this recurrence equation may have power-law solutions Vₙ=λⁿ provided that λ satisfies the quadratic equation, λ²−Pλ+Q=0, whose solutions are 2,2D=P²_4Q.

$${λ}_{\pm } = \frac{P \pm \sqrt{D}}{2} , D = {P}^{2} - 4 Q .$$

The recurrence solutions

$${λ}_{\pm }^{n}$$

satisfy the condition λ₊λ₋=Q and may be used to build the Lucas sequence of the first kind (conventionally denoted using letters U rather than V), with the following initial values,

$${U}_{0} = 0 , {U}_{1} = 1 ; \to {U}_{n} = \frac{{λ}_{+}^{n} - {λ}_{-}^{n}}{{λ}_{+} - {λ}_{-}} ,$$

and further build the Lucas number sequence of the second kind, with different initial values,

$${V}_{0} = 2 , {V}_{1} = P ; \to {V}_{n} = {λ}_{+}^{n} + {λ}_{-}^{n} .$$

The expression for Vₙ may be used to obtain the following relation between adjacent elements of the Lucas sequence of the second kind,

$${( 2 {V}_{n + 1} - {PV}_{n} )}^{2} = D ( {V}_{n}^{2} - 4 {Q}^{n} ) .$$

In some implementations, operations 200 may be performed using Q=1 and a suitably chosen value P, as disclosed below.

The Lucas number sequence of the second kind is periodic on the finite field [symbol] ₚ, meaning that after some number m of steps, the starting values V₀=2, V₁=P are repeated, →Vₘ=2, Vₘ₊₁=P, making up one period of this number sequence. Such repetition may occur in one of the three possible scenarios. In one scenario, at some step n, the two consecutive values coincide, Vₙ₊₁=Vₙ, with (as follows from the above relation between the adjacent elements),

$${V}_{n} = \sqrt{P + 2} .$$

In the second scenario, at some step n, the two consecutive values are opposite, Vₙ₊₁=−Vₙ, with (as follows from the relation between the adjacent elements)

$${V}_{n} = \sqrt{P - 2} .$$

In the third scenario, at some step n, one of the consecutive values is zero, Vₙ=0, with (as follows from the same relation between the adjacent elements)

$${V}_{n + 1} = {V}_{n - 1} = \sqrt{4 - {P}^{2}} .$$

Correspondingly, if one chooses a value

$$P = 2 \frac{{a}^{2} - {b}^{2} X}{{a}^{2} + {b}^{2} X}$$

with some (e.g., randomly chosen) values (a, b), then the values Vₙ₊₁ and Vₙ₋₁ in the third scenario are

$${V}_{n + 1} = {V}_{n - 1} = \frac{4 ab \sqrt{X}}{{a}^{2} + {b}^{2} X} .$$

Correspondingly, the square root of the input value may be computed as follows:

$$Y ≡ \sqrt{X} = {V}_{n \pm 1} \frac{{a}^{2} + {b}^{2} X}{4 ab}$$

In some implementations, one of the numbers a or b can be set to a fixed value, e.g., b=1, whereas the other value, e.g., a, may be randomly selected until such a is selected that the third scenario is realized.

With the above as the backdrop, operations 200 of FIG. 2 may be performed as follows. At block 210, an input value X may be received by a processing device, e.g., fetched from memory, received over a suitable bus or another communication channel, computed by the processing device in one of earlier computations performed by the processing device and remaining accessible in a cache of the processing device, and/or obtained in any other manner. At block 215, the processing device may check whether X=0, in which case Y=\sqrt{X}=0 is returned as the output (block 220).

In the instance of a non-zero input X, operations 200 may proceed with selecting a number a (or a number b or both numbers a and b) randomly, pseudorandomly, or deterministically (block 230) and compute the first parameter P of the Lucas number sequence (block 240), e.g. one may select b=1, obtaining

$$P = 2 \frac{{a}^{2} - X}{{a}^{2} + X} .$$

The number a may be selected on a ring a ∈[1, p−1], excluding the null value a=0. In computing value P, the processing device encounters a division operation (a²+X)⁻¹ that may be computationally costlier than a multiplication. Given the likely subsequent use (later in the operations 200) of another division operation (4a)⁻¹, the two divisions may be computed as a batch multiplication where a single division is used to compute an auxiliary value A=[4a(a²+X)]⁻¹ with the two target division values then computed using (faster and less resource-consuming) multiplications, e.g.,

$${( {a}^{2} + X )}^{- 1} = 4 a * A , {( 4 a )}^{- 1} = ( {a}^{2} + X ) * A .$$

In some implementations, multiple values aⱼ may be pre-selected for a given input X and the batch computation may involve pre-computing several values

$${A}_{j} = {[ 4 {a}_{j} * ( {a}_{j}^{2} + X ) ]}^{- 1} .$$

In some implementations, multiple inputs Xᵢ may be received with one or more values aⱼ selected for each input with the batch pre-computation used to compute multiple values

$${A}_{ij} = {[ 4 {a}_{j} * ( {a}_{j}^{2} + {X}_{i} ) ]}^{- 1} .$$

Although in the above example, a specific parametrization P(a) is illustrated, various other parametrizations may be used, such that P²(a)=x*[f(a, X)]², where f(a, X) is any value that changes with a and, possibly, with X.

At block 250 the second parameter Q of the Lucas number sequence may be set, which may be a fixed value that is independent of the input X, e.g., Q=1.

At block 260, starting values for the Lucas number sequence may be set, e.g., V₀=2, and V₁=P for the Lucas sequence of the second kind.

At block 270, the processing device may run the Lucas number sequence for one period (or less), computing Vₙ for incremented values of the index n=2, 3, . . . . At decision-making block 275, the processing device may determine whether the Lucas number sequence initiated with the current value a has reaches a state where Vₙ=0. If no such state occurs during any of the iterations (steps) of the Lucas number sequence, the processing device may determine, at the decision-making block 285 whether the period divides p−1, that is, whether Vₚ₋₁=2. If this occurs, operations 200 return to block 230 where a new value a is generated and blocks 240-275 are repeated. If the period does not divide p−1, the processing device may output (at block 295) that no square root Y≡\sqrt{X} exists for the input X.

In some implementations, computations of block 270 may be performed using a Montgomery ladder. More specifically, a state of the ladder may be initialized using value V₀=2 as one of the values (also referred to as V herein) and V₁=P as another value Wof the state (also referred to as W herein): (V, W)←(2, P). A plurality of iterations of the Montgomery ladder may be indexed by i, with i decremented from i=└log₂ p┘ until i=2 is reached. At each step of the ladder, the following operations may be performed:
if ith bit of p is 0, the state of the ladder is updated according to:

$$( V , W ) ← ( {V}^{2} - 2 , V * W - P ) ;$$

if ith bit of p is 1, the state of the ladder is updated according to:

$$( V , W ) ← ( V * W - P , {V}^{2} - 2 ) .$$

For the square root \sqrt{X} to exist, one of the three scenarios described above, namely Vₙ=0, Vₙ₊₁=Vₙ, or Vₙ₊₁=−Vₙ, has to happen within the last several iterations of a period, before Vₙ returns to value 2. When a state of the Lucas number sequence (e.g., the state of the Montgomery ladder) is detected where Vₙ=0 (e.g., value V of the Mongomery ladder), operations 200 proceed to block 280 where the square root value is then determined using one of the (equal) values, V_{n±1}(value W of the Mongomery ladder),

$$Y ≡ \sqrt{X} = {V}_{n \pm 1} * {( 4 a )}^{- 1} * ( {a}^{2} + X ) ,$$

and the pre-computed value (4a)⁻¹. The computed value Y≡\sqrt{X} is returned in block 290. It is to be emphasized that the division operation involved in computation of \sqrt{X} is a division by a fixed number (namely, 4a) that can be pre-computed using the batch division and applied via a fast multiplication operation at the end of square root computations. This represents an improvement over the Kim-Koo-Kwon algorithm where a division operation is by an X-dependent value (W) that is not known until the end of computations. Since there is no need to perform a separate input-dependent division operation (like in the Kim-Koo-Kwon algorithm), the implementations of the instant disclosure enable faster computations.

In some implementations, an occurrence of one of the situations of W=±V (or, equivalently, Vₙ₊₁=±Vₙ) can be predicted prior to performing computations of the Montgomery ladder, in which instance the square root \sqrt{X} may be found by diverting the computations to a different path directly from the value V (or W). More specifically, together with computation of the inverse value A=[4a(a²+X)]⁻¹ (e.g., at block 230, as described above), operations 200 may include computing the value χ=(a²X−4)^{(N-1)/2}. If χ=−1, the computations may be performed similarly to the above but starting from P=a²X−2. Correspondingly, when the situation W=V is encountered,

$$V = \sqrt{2 + P} = a \sqrt{X} .$$

the square root value \sqrt{X} may be computed by the division operation (or multiplication by the inverse a⁻¹), \sqrt{X}=a⁻¹*V=A*4(a²+X)*V.

In some implementations, the determination that no \sqrt{X} exists may be made early in the operations 200, e.g., prior to operations of blocks 230-270 or at least some of operations of these blocks, e.g., by computing a Jacobi symbol

$$( \frac{X}{p} ) .$$

In those implementations where the Jacobi symbol is determined to be −1 (indicating that no such that Y exists for which Y²=X) the operations 200 may proceed directly to block 295.

In some implementations, the Lucas number sequences may also be used to test whether a given number N (e.g., a randomly generated number) is a prime number or a composite number (a number having factors that are different from 1 and the number itself). Such primality tests are used in cryptographic applications, e.g., to select a private/public key pair, a modulus value (ring size) for modular computations, and/or various other purposes.

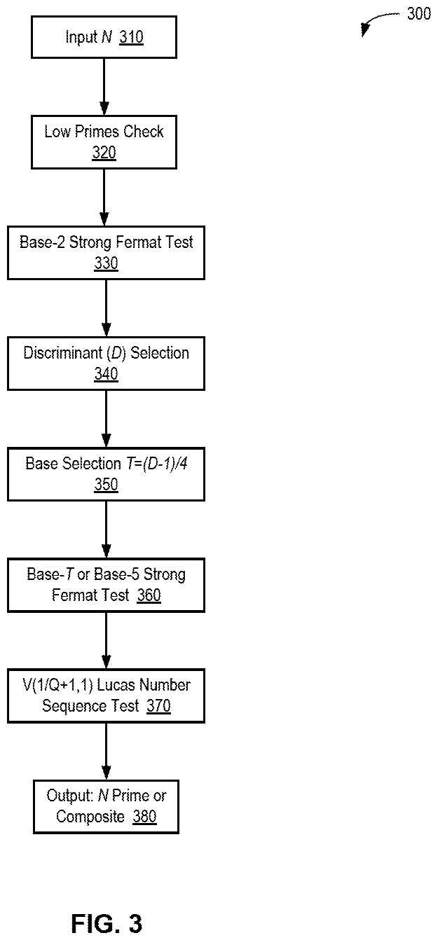

FIG. 3 illustrates schematically a flowchart of example operations 300 of using a Lucas number sequence for primality testing in cryptographic applications, in accordance with one or more aspects of the present disclosure. In one example illustrative implementation, an efficient primality testing may be performed as specified in the Algorithm below.

Algorithm: Primality testing with Lucas number sequence:

```
Require: Inputs N ∈ N
Ensure: Output prime? if N is prime.
        Otherwise, return composite.
      1: if N ∈ {2, 3, 5, 7, 11} then return prime?
      2: else if N is even or N < 13 then return composite [symbol]
First strong Fermat test
      3: if StrongFermatTest(N, 2) = composite then return composite
      4: for |D| ∈ [5, 7, 9, 11, 13, ... ] do
```

| | |
|---|---|
| 5: if D ≠ 15 and \|D\| is composite then next \|D\| | [symbol] Optionally, skip these \|D\| |

```
      6:  $Calculate δ ← ( \frac{\vert D \vert}{N} )$
      7: if δ = −1 then break with |D|
      8: else if δ = 0 then return composite
      9:  $Set T ← ⌊ \frac{\vert D \vert + 1}{4} ⌋ , and s := \{ \begin{matrix}+ 1 if \vert D \vert = 1 mod 4 \\ - 1 if \vert D \vert = 3 mod 4\end{matrix}$
    10: if |T] = 2^{k} for some k then
    11: [symbol]   A base-T Fermat test would be redundant, so use base 5 instead
    12: if StrongFermatTest(N, 5) = composite then return composite
    13: Calculate T⁻¹ mod N using Montgomery reduction
    14: else
    15: if StrongFermatTest(N, T) = composite then return composite
    16: Extract T⁻¹ = T^{N-2} from the strong Fermat test
    17: Let [symbol]  ← v(N + 1), the number of trailing zero-bits of N + 1
    18: Initialize V ← 2, P ← T⁻¹ + 2s, W ← P, ok ← false
```

| | |
|---|---|
| 19: for b = [log₂ N] down to 2 do | [symbol] Montgomery ladder with termination |

```
    20: if bit b of N is 0 then (V, W) ← (V² − 2, VW − P)
    21: else (V, W) ← (VW − P, W² − 2)
    22: if b = [symbol]   + 1 and V = ±W then return prime?
    23: else if b ≤ [symbol]  and W = 0 then then return prime?
    24: else return composite
```

Algorithm may start with receiving, fetching, or generating an input candidate prime number N(block 310 in FIG. 3). At lines 1-2, the Algorithm may check a number of low primes, e.g., N<13 (block 320 in FIG. 3). The Algorithm may also determine even N (other than 2) as composites. At line 3, the Algorithm may perform a strong Fermat test, e.g., base-2 strong Fermat test (block 330 in FIG. 3). More specifically, the odd part Nₒ of N−1 may be computed, e.g., by dividing N−1 by the maximum possible power k of 2, followed by computing a number α=2^{N}^{ₒ}. If number α=1 mod N or α is congruent to −1 mod N, then N passes the strong Fermat test. Otherwise, as part of the strong Fermat test, the number α is squared k−1 times. In that case, N passes the strong Fermat test if at least one of such consecutive squares is congruent to −1 mod N. This Jacobi symbol is easily computed from the value of N mod 8. If N does not pass the strong Fermat test, then N is always composite, yet passing this test does not guarantee than N is prime. The Fermat test may also be performed with a base A other than 2, for which N does not divide A, by computing α=A^{N}^{ₒ} instead of α=2^{N}^{ₒ} The Fermat test may also be modified to additionally calculate A^{N-2} mod N. If N passes the strong Fermat test, then the value A^{N-2} mod N equals A⁻¹ mod N.

The Fermat test is followed by a Lucas test, which starts with choosing a discriminant D with the absolute value |D| from the sequence [5, 7, 9, 11, 13, . . . ] at line 4 of the Algorithm to ensure that D+1 is divisible by 4 (block 340 in FIG. 3). The Jacobi symbol

$$δ = ( \frac{D}{N} )$$

(may be computed and evaluated (lines 6-8 of the Algorithm). Equivalently, the Jacobi symbol may be computed as

$$δ = ( \frac{N}{\vert D \vert} ) .$$

A zero Jacobi symbol δ indicates that D is divisible by N in which instance N is determined to be composite. The Jacobi symbol is used to identify the first discriminant D with Jacobi symbol

$$δ = ( \frac{D}{N} ) = - 1 ,$$

meaning that that D is quadratic non-residue modulo N (that no such z exists that z²=D mod N).

At line 9 of the Algorithm, the selected value D is used to determine parameter T of the Lucas number sentence. In some implementations, the parameter T is selected according to

$$T = ⌊ \frac{1 + \vert D \vert}{4} ⌋$$

(block 350 in FIG. 3). If |T| is a power of 2, a second (base-5) strong Fermat test may be performed (line 12 of the Algorithm and block 360 in FIG. 3) which may be followed by calculating the inverse value T⁻¹ mod N. This may be performed using the Montgomery reduction techniques (line 13 of the Algorithm). In those instances where |T| is not a power of 2, the second strong Fermat test may be performed base-T (lines 14-15 of the Algorithm) with the inverse value T⁻¹=T^{N-2} extracted as part of the test (line 16 of the Algorithm).

The Lucas number sequence Vₙ(P, Q) may next be computed (e.g., as disclosed above in conjunction with the square root algorithm) whose parameters may be P=T⁻¹+2s and Q=1, with V₀=2, and V₁=P (lines 17-24 of the Algorithm and block 370 in FIG. 3), and value s=+1 used if |D|=1 mod 4, value s=−1 used if |D|=3 mod 4. The Lucas number sequence test passes if one of the following situations is realized. (1) Value W=0 is encountered during one of the last [symbol] −1 iterations. (2) One of the values V=±W is encountered during the last [symbol] th iteration. This amounts to checking not only that the Lucas number sequence has reached value V_{(N+1)/2}=±2 or V_{(N-1)/2}=±2, but also that it did so in a way that is compatible with N being a prime number. The operations of FIG. 3 may conclude with outputting an indication whether Nis prime or composite (block 380 in FIG. 3). The question of whether such a test is definitive is an unresolved mathematical question: it never indicates that a prime number N is composite, but there might exist a composite number N that the test incorrectly indicates to be prime.

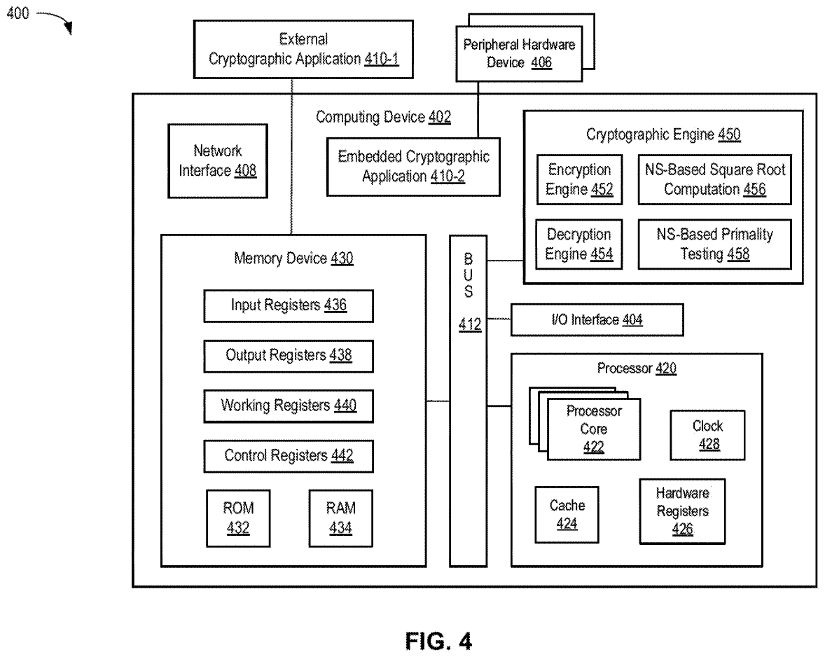

FIG. 4 is a block diagram illustrating an example computing platform 400 capable of supporting NS-based computations of square roots and NS-based primality testing in cryptographic applications, in accordance with one or more aspects of the present disclosure. Example computing device 400 may be or include a desktop computer, a tablet, a smartphone, a server (local or remote), a thin/lean client, and the like. Example computing platform 400 may be a smart card reader, a wireless sensor node, an embedded system dedicated to one or more specific applications (e.g., cryptographic applications 410-n), and so on. Example computing platform 400 may include (but need not be limited to) a computing device 402 having one or more processors 420 (e.g., central processing units (CPUs)) capable of executing binary instructions, and one or more memory devices 430. Herein “processor” or “processing device” refers to a device capable of executing instructions encoding arithmetic, logical, or I/O operations. In one illustrative example, a processing device may follow von Neumann architectural model and may include an arithmetic logic unit (ALU), a control unit, and a plurality of registers. A processing device may be a single-core processor capable of executing one instruction at a time (or process a single pipeline of instructions), or a multi-core processor capable of simultaneous execution of multiple instructions. A processing device may be implemented as a single integrated circuit, two or more integrated circuits, or may be a component of a multi-chip module. A processing device may be or include a CPU, a graphics processing unit (GPU), a field-programmable gate array (FPGA), an application-specific integrated circuit (ASIC), or any combination thereof.

Computing device 402 may include an input/output (I/O) interface 404 to facilitate connection of computing device 402 with peripheral hardware devices 406, such as card readers, terminals, printers, scanners, internet-of-things devices, and the like. Computing device 402 may further include a network interface 408 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from the computing device 402. For example, network interface 408 may be used to support a connection to receiving device 102 and/or sending device 120 of FIGS. 1A-1B. Various hardware components of computing device 402 may be connected via a bus 412, which may have its own logic circuits.

Example computing platform 400 may support one or more cryptographic applications 410-n, such as one or more external cryptographic applications 410-1 and/or one or more embedded cryptographic applications 410-2. Cryptographic applications 410-n may be secure authentication applications, public key signature applications, key encapsulation applications, key decapsulation applications, encryption applications, decryption applications, fully homomorphic encryption/decryption applications, secure storage applications, and so on. External cryptographic application 410-1 may be instantiated on the same computing device 402, e.g., by an operating system executed by the processor 420 and residing in a memory device 430. Alternatively, external cryptographic application 410-1 may be instantiated by a guest operating system supported by a virtual machine monitor (hypervisor) executed by the processor 420. In some implementations, external cryptographic application 410-1 may reside on a remote access client device or a remote server (not shown), with the computer device 402 providing cryptographic support for the client device and/or the remote server.

Processor 420 may include one or more processor cores 422 having access to cache 424 (e.g., a single-level or multi-level cache) and one or more hardware registers 426. In some implementations, each processor core 422 may execute instructions to run a number of hardware threads, also known as logical processors. Various logical processors (or processor cores) may be assigned to one or more cryptographic applications 410-n, although more than one processor may be assigned to a single cryptographic application for parallel processing. Memory device 430 may refer to a volatile or non-volatile memory and may include a read-only memory (ROM) 432, a random-access memory (RAM) 434, as well as (not shown) electrically erasable programmable read-only memory (EEPROM), flash memory, flip-flop memory, or any other device capable of storing data. RAM 434 may be a dynamic random access memory (DRAM), synchronous DRAM (SDRAM), a static memory, such as static random access memory (SRAM), and the like.

Memory device 430 may include one or more registers, such as one or more input registers 436 to store cryptographic keys, input polynomials, and other data for cryptographic applications 410-n. Memory device 430 may further include one or more output registers 438 to store outputs of cryptographic application, and one or more working registers 440 to store various intermediate values generated in the course of performing cryptographic computations, including masking operations. Memory device 430 may also include one or more control registers 442 for storing information about modes of operation, selecting a cryptographic algorithm, initializing cryptographic computations, selecting a masking mode, selecting ring Z_{q}, performing masking and reverse decomposition, and/or the like. Control registers 442 may communicate with one or more processor cores 422 and a clock 428, which may keep track of a processing operation (e.g., iteration or step of the Lucas number sequence) being performed. In some implementations, registers 436-442 may be implemented as part of RAM 434. In some implementations, some or all of the registers 436-442 may be implemented separately from RAM 434. Some of or all registers 436-442 may be implemented as part of processor 420 (e.g., as part of the hardware registers 426). In some implementations, processor 420 and memory device 430 may be implemented as a single field-programmable gate array (FPGA).

Computing device 402 may include a cryptographic engine 450 to support cryptographic operations of processor 420. Cryptographic engine 450 may be configured to facilitate encryption operations, decryption operation, digital signature operations, key encapsulation operations, and/or any other applicable cryptographic operations, in accordance with implementations of the present disclosure. As depicted in FIG. 4, cryptographic engine 450 may be a separate hardware component, e.g., an accelerator. In some implementations, cryptographic engine 450 may be implemented as a software (or firmware) module instantiated in memory device 430. In some implementations, cryptographic engine 450 may be partially implemented as a hardware component and partially as a software (or firmware) module. Cryptographic engine 450 may include an encryption engine 452 to encrypt plaintext messages and generate ciphertexts. Cryptographic engine 450 may also include a decryption engine 454 to decrypt ciphertexts and recover plaintext messages. Encryption engine 452 and/or decryption engine 454 may use a NS-based square root computation 456 and/or NS-based primality testing 458 for efficient implementation of cryptographic applications, e.g., as described in more detail in conjunction with FIGS. 1A-1B and FIGS. 2-3 above.

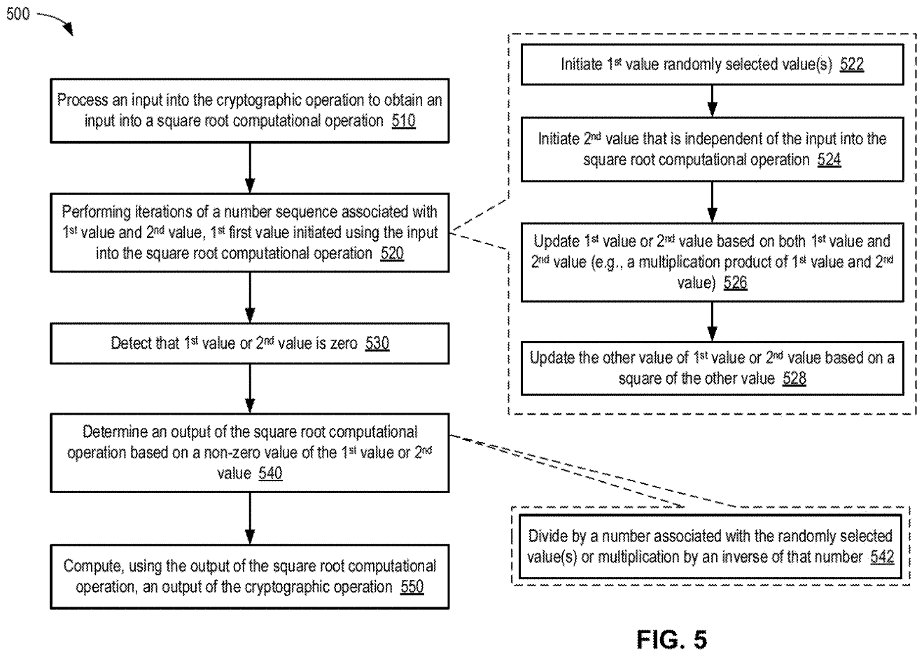

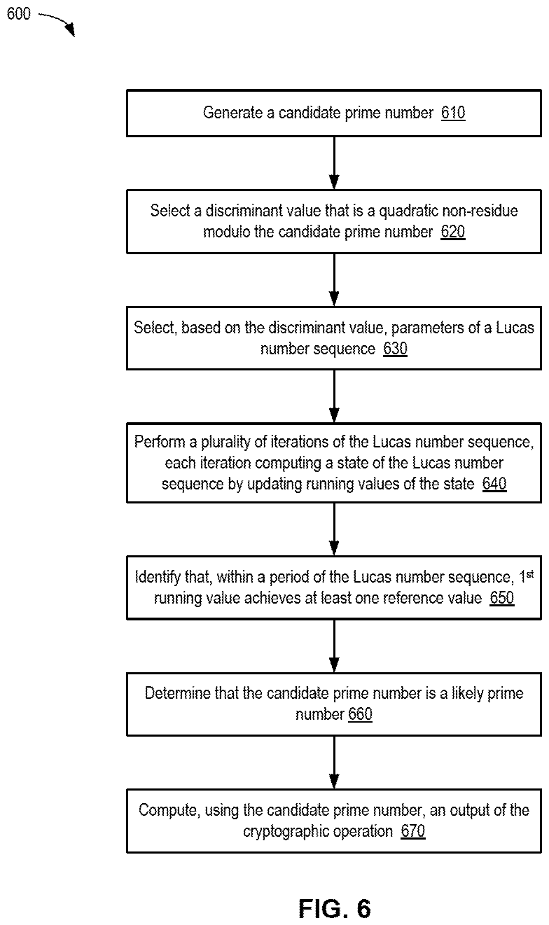

FIGS. 5-6 illustrate methods 500 and 600 directed to Lucas number sequence-based computations of square roots and primality testing of candidate prime numbers. Methods 500 and/or 600 and any, some, or all of their individual functions, routines, subroutines, or operations may be performed by one or more processing units of a suitable computing system, e.g., by processor 420 and/or cryptographic engine 450 of computing device 402 in FIG. 4. In some implementations, methods 500 and/or 600 may be performed by an arithmetic logic unit, an FPGA, an ASIC, a cryptographic accelerator, a dedicated hardware circuit, and the like, or any suitable processing logic, hardware or software or a combination thereof. In certain implementations, methods 500 and/or 600 may be performed by a single processing thread. Alternatively, methods 500 and/or 600 may be performed by two or more processing threads, each thread executing one or more individual functions, routines, subroutines, or operations of the method. In an illustrative example, the processing threads implementing methods 500 and/or 600 may be synchronized (e.g., using semaphores, critical sections, and/or other thread synchronization mechanisms). Alternatively, the processing threads implementing methods 500 and/or 600 may be executed asynchronously with respect to each other. Various operations of methods 500 and/or 600 may be performed in a different order compared with the order shown in FIG. 5 and/or FIG. 6. Some blocks of methods 500 and/or 600 may be performed concurrently with other blocks. Some blocks of methods 500 and/or 600 may be optional.

FIG. 5 depicts a flow diagram of an example method 500 of using Lucas number sequences in computations of square roots in cryptographic applications, in accordance with one or more aspects of the present disclosure. In some implementations, method 500 may be performed to process (or as part of processing) an input into a cryptographic operation. In some implementations, the cryptographic operation may include a digital signature operation, an plaintext encryption operation, a ciphertext decryption operation, a key encapsulation operation, and/or the like.

In some implementations, as illustrated in FIG. 5, method 500 may include receiving an input into the cryptographic operation, e.g., a plaintext to be encrypted, a ciphertext to be decrypted, a data to be authenticated, a cryptographic key to be used in the aforementioned operations, one or more nonce values, counter values, and/or the like. At block 510, a processing device performing operations of method 500 may process the input into the cryptographic operation to obtain an input into a square root computational operation (e.g., input value X).

At block 520, method 500 may include performing a plurality of iterations of a Lucas number sequence associated with a first value (e.g., W) and a second value (e.g., V). In one example, the Lucas number sequence, e.g., the Lucas number sequence of the second kind, Vₙ(P, Q). In some implementations, the plurality of iterations may be performed using Montgomery ladder computations to update a pair of values (e.g., V and W) at each step of the computation. In some implementations, the first value may be initiated using the input into the square root computational operation. For example, the initiation of the first value may be performed as follows

$$W ≡ {V}_{1} ← P ← 2 \frac{{a}^{2} - {b}^{2} X}{{a}^{2} + {b}^{2} X} .$$

In some implementations, performing the plurality of iterations of the Lucas number sequence may include operations illustrated with the top callout portion of FIG. 5. More specifically, at block 522, the initiation of the first value may be performed using one or more randomly selected values (e.g., a, b, and/or the like). In some implementations, the first value may be initiated using a first inverse value (e.g., (a²+b²X)⁻¹). In some implementations, the first inverse value may be computed together with a second inverse value (e.g., (4ab)⁻¹) using a batch division operation (e.g., computing a single division A=[4ab(a²+b²X)]⁻¹ followed by two or more multiplications, e.g., 4ab*A and (a²+b²X)*A]), with the second inverse value being subsequently used as part of block 540, as disclosed below).

At block 524, method 500 may include initiating the second value with a value that is independent of the input into the square root computational operation, e.g.,

$$V ≡ {V}_{0} ← 2 .$$

or some other suitable value.

At block 526, method 500 may include updating one of the first value or the second value based on each of the first value and the second value, e.g., based on a multiplication product of the first value and the second value (for example, performing one of the update operations, V←V*W−P or W←V*W−P contingent on respective values of a control bit for the iteration).

At block 528, method 500 may include updating the other value of the first value or the second value based on a square of the other value (e.g., performing one of the update operations, V←V²−2 or W←W²−2).

At block 530, method 500 may continue with detecting that one of the first value or the second value is zero (e.g., detect that V=0 or W=0) during one of the iterations being performed.

At block 540, method 500 may include determining an output of the square root computational operation based on another one of the second value or the first value (e.g., determining \sqrt{X} based on W, if V=0, or determining \sqrt{X} based on V, if W=0). In some implementations, as illustrated with the bottom callout block 542, determining the output of the square root computational operation includes a division by a number (e.g., 4ab) associated with the one or more randomly selected values (e.g., computing V÷(4ab) or W÷(4ab)), or a multiplication by an inverse of that number (e.g., computing V*(4ab)⁻¹ or W*(4ab)⁻¹). Various additional operations may be used to determine \sqrt{X} (including but not limited to a multiplication by (a²+b²X), as disclosed above in conjunction with FIG. 2).

At block 550, method 500 may continue with computing, using the output of the square root computational operation (e.g., \sqrt{X}), an output of the cryptographic operation associated with the input into the cryptographic operation, e.g., determining a y-coordinate of a point on an elliptic curve based on the point's x-coordinate and then using the determined coordinate in elliptic curve cryptographic computations. The output of the cryptographic operation may include a digital signature for the input into the cryptographic operation, an encryption of the input into the cryptographic operation, a decryption of the input into the cryptographic operation, and/or the like.

In some implementations, operations illustrated in FIG. 5 may be aborted prior to performance of any, some, or all illustrated operations. More specifically, the processing device performing method 500 may also compute a Jacobi symbol for the input into the square root computational operation (e.g., the Jacobi symbol

$$( \frac{X}{p} ) ,$$

where p is a modulus value). In such implementations, the processing device may determine, based on the computed Jacobi symbol (e.g., based on the Jacobi symbol being equal to −1), that the input does not have a square root (e.g., that X is quadratic non-residue modulo p).

In some implementations, operations of method 500 may include detecting that the first value (e.g., W) or the second value (e.g., V) has one of non-zero target values. For example, the processing device may detect that the first value is equal to the second value (e.g., W=V) or that the first value is equal to a negative of the second value (e.g., W=−V) and may determine the output of the square root computational operation (e.g., \sqrt{X}) based on the first value or the second value (e.g., based on W or −W being equal to \sqrt{2+P} or \sqrt{2−P}, as disclosed above in conjunction with FIG. 2).

FIG. 6 depicts a flow diagram of an example method 600 of using Lucas number sequences in primality testing in cryptographic applications, in accordance with one or more aspects of the present disclosure. At block 610, operations of method 600 may include generating, by a processing device, a candidate prime number. At block 620, method 600 may include selecting a discriminant value (e.g., value D, with reference to Algorithm) that is a quadratic non-residue modulo the candidate prime number. At block 630, method 600 may continue with selecting, based on the discriminant value, a plurality of parameters of a Lucas number sequence (e.g., values T, P, W, and/or the like, with reference to Algorithm). For example, a first parameter of the plurality of parameters (e.g., P) may be selected based on the discriminant value and a second parameter of the plurality of parameters is selected to be number 1 (e.g., Q=1). At block 640, method 600 may include performing a plurality of iterations of the Lucas number sequence. Each iteration may compute a state of the Lucas number sequence by updating one or more running values (e.g., V, W) of the state of the Lucas number sequence. In some implementations, the plurality of iterations are performed using a Montgomery ladder. At block 650, method 600 may include identifying that, within a period of the Lucas number sequence (whose length may be (N+1)/2, in one example), a first running value of the one or more running values (e.g., V) achieves at least one reference value of a plurality of reference values. The reference values may include a zero value (e.g., V=0), a second running value of the plurality of running values (e.g., V=W), or a negative second running value of the plurality of running values (e.g., V=−W). At block 660, method may include determining, based on the identifying at block 650, that the candidate prime number is a likely prime number. In some implementations, determining that the candidate prime number is the likely prime number may further comprises performing one or more of a base-2 primality test, a base-5 primality test, a primality test for a base value determined based on the discriminant value, and/or the like.

At block 660, method 600 may continue with computing, by the processing device and using the candidate prime number, an output of the cryptographic operation associated with the input into the cryptographic operation. For example, computing the output of the cryptographic operation may include generating, using the candidate prime number, a cryptographic key associated with the cryptographic operation. Computing the output may further include computing, using the cryptographic key, the output of the cryptographic operation. In some implementations, the output of the cryptographic operation may include a digital signature for the input into the cryptographic operation, an encryption of the input into the cryptographic operation, a decryption of the input into the cryptographic operation, and/or the like.

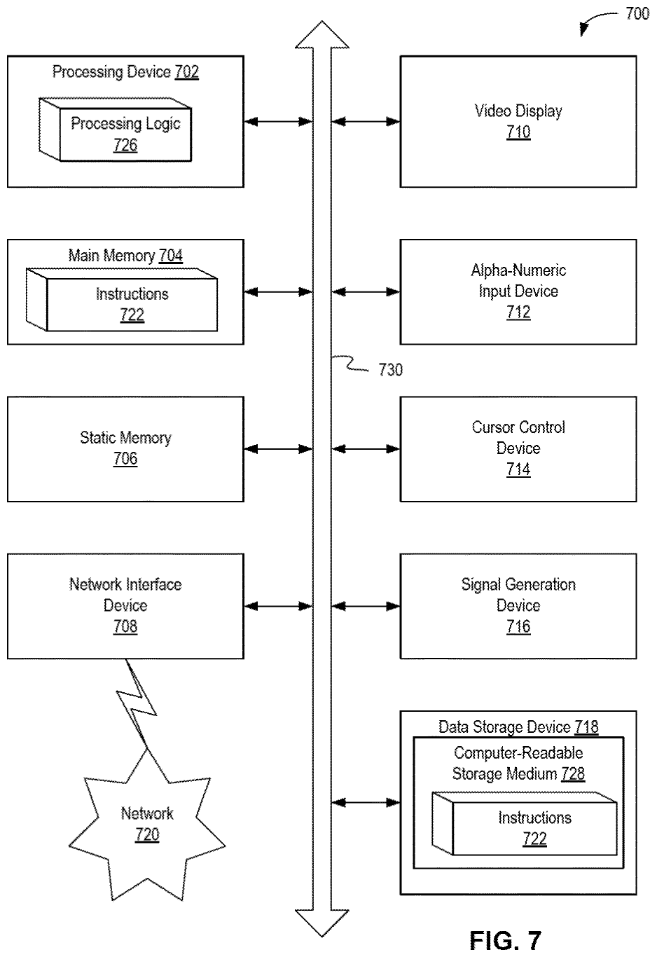

FIG. 7 depicts a block diagram of an example computer system 700 operating in accordance with one or more aspects of the present disclosure. In various illustrative examples, computer system 700 may represent computing device 402, illustrated in FIG. 4. Example computer system 700 may be connected to other computer systems in a LAN, an intranet, an extranet, and/or the Internet. Computer system 700 may operate in the capacity of a server in a client-server network environment. Computer system 700 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 700 may include a processing device 702 (also referred to as a processor or CPU), which may include processing logic 726, a main memory 704 (e.g., read-only memory (ROM), flash memory, dynamic random access memory (DRAM) such as synchronous DRAM (SDRAM), etc.), a static memory 706 (e.g., flash memory, static random access memory (SRAM), etc.), and a secondary memory (e.g., a data storage device 718), which may communicate with each other via a bus 730.

Processing device 702 represents one or more general-purpose processing devices such as a microprocessor, central processing unit, or the like. More particularly, processing device 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 702 may be configured to execute instructions implementing example method 500 of using number sequences in computations of square roots in cryptographic applications and/or example method 600 of using number sequences in primality testing in cryptographic applications.

Example computer system 700 may further comprise a network interface device 708, which may be communicatively coupled to a network 720. Example computer system 700 may further comprise a video display 710 (e.g., a liquid crystal display (LCD), a touch screen, or a cathode ray tube (CRT)), an alphanumeric input device 712 (e.g., a keyboard), a cursor control device 714 (e.g., a mouse), and an acoustic signal generation device 716 (e.g., a speaker).

Data storage device 718 may include a computer-readable storage medium (or, more specifically, a non-transitory computer-readable storage medium) 728 on which is stored one or more sets of executable instructions 722. In accordance with one or more aspects of the present disclosure, executable instructions 722 may comprise executable instructions implementing example method 500 of using number sequences in computations of square roots in cryptographic applications and/or example method 600 of using number sequences in primality testing in cryptographic applications.

Executable instructions 722 may also reside, completely or at least partially, within main memory 704 and/or within processing device 702 during execution thereof by example computer system 700, main memory 704 and processing device 702 also constituting computer-readable storage media. Executable instructions 722 may further be transmitted or received over a network via network interface device 708.

While the computer-readable storage medium 728 is shown in FIG. 7 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method comprising:
processing, by a processing device, an input into a cryptographic operation to obtain an input into a square root computational operation;
performing a plurality of iterations of a Lucas number sequence associated with a first value and a second value, the first value initiated using the input into the square root computational operation and a first inverse value, wherein an individual iteration of the plurality of iterations comprises at least:
updating one of the first value or the second value based on each of the first value and the second value;
detecting that one of the first value or the second value is zero;
determining an output of the square root computational operation based on at least (i) another one of the second value or the first value and (ii) a second inverse value, wherein the first inverse value and the second inverse value are computed using a batch division operation; and
computing, by the processing device and using the output of the square root computational operation, an output of the cryptographic operation associated with the input into the cryptographic operation.

2. The method of claim 1, wherein the output of the cryptographic operation comprises at least one of:
a digital signature for the input into the cryptographic operation,
an encryption of the input into the cryptographic operation, or
a decryption of the input into the cryptographic operation.

3. The method of claim 1, wherein the Lucas number sequence comprises a Lucas number sequence of a second kind.

4. The method of claim 1, wherein the plurality of iterations is performed using Montgomery ladder computations.

5. The method of claim 1, wherein the first value is further initiated using one or more randomly selected values.

6. The method of claim 5, wherein determining the output of the square root computational operation comprises at least one of:
division by a number associated with the one or more randomly selected values, or
multiplication by an inverse of the number.

7. The method of claim 1, wherein the second value is initiated with a value that is independent of the input into the square root computational operation.

8. The method of claim 1, wherein the updating one of the first value or the second value based on each of the first value and the second value comprises:
updating the one of the first value or the second value based on a multiplication product of the first value and the second value.

9. The method of claim 1, wherein the individual iteration of the plurality of iterations further comprises:
updating the other value of the first value or the second value based on a square of the other value.

10. The method of claim 1, further comprising:
obtaining an additional input into the square root computational operation;
computing a Jacobi symbol for the additional input; and
determining, based on the computed Jacobi symbol, that the additional input does not have a square root.

11. The method of claim 1, further comprising:
processing an additional input into the cryptographic operation to obtain an additional input into a square root computational operation;
performing a plurality of additional iterations of the Lucas number sequence associated with a third value and a fourth value, the third value initiated using the additional input into the square root computational operation, wherein an individual additional iteration of the plurality of additional iterations comprises at least:
updating one of the third value or the fourth value based on each of the third value and the fourth value;
detecting that the third value is equal to at least one of the fourth value or a negative to the fourth value; and
determining an additional output of the square root computational operation based on at least one of the third value or the fourth value.

12. A system comprising:
a memory device; and
a processing device communicatively coupled to the memory device, the processing device to:
process an input into a cryptographic operation to obtain an input into a square root computational operation;
perform a plurality of iterations of a Lucas number sequence associated with a first value and a second value, the first value initiated using the input into the square root computational operation and a first inverse value, wherein an individual iteration of the plurality of iterations comprises at least:
updating one of the first value or the second value based on each of the first value and the second value;
detect that one of the first value or the second value is zero;
determine an output of the square root computational operation based on at least (i) another one of the second value or the first value and (ii) a second inverse value, wherein the first inverse value and the second inverse value are computed using a batch division operation; and
compute, by the processing device and using the output of the square root computational operation, an output of the cryptographic operation associated with the input into the cryptographic operation, wherein the output of the cryptographic operation comprises at least one of:
a digital signature for the input into the cryptographic operation,
an encryption of the input into the cryptographic operation, or
a decryption of the input into the cryptographic operation.

13. The system of claim 12, wherein the output of the cryptographic operation comprises at least one of:
a digital signature for the input into the cryptographic operation,
an encryption of the input into the cryptographic operation, or
a decryption of the input into the cryptographic operation.

14. The system of claim 12, wherein the Lucas number sequence comprises a Lucas number sequence of the second kind.

15. The system of claim 12, wherein the plurality of iterations is performed using Montgomery ladder computations.

16. The system of claim 12, wherein the first value is further initiated using one or more randomly selected values, and wherein the second value is initiated with a value that is independent of the input into the square root computational operation.

17. The system of claim 16, wherein to determine the output of the square root computational operation, the processing device it to perform at least comprises at least one of:
division by a number associated with the one or more randomly selected values, or
multiplication by an inverse of the number.

18. The system of claim 12, wherein the second value is initiated with a value that is independent of the input into the square root computational operation.

19. The system of claim 12, wherein to update the one of the first value or the second value based on each of the first value and the second value, the processing device is to:
update the one of the first value or the second value based on a multiplication product of the first value and the second value, and wherein the individual iteration of the plurality of iterations further comprises:
update the other value of the first value or the second value based on a square of the other value.

20. A non-transitory computer-readable memory storing instructions that, when executed by a processing device, cause the processing device, comprising:
processing, by a processing device, an input into a cryptographic operation to obtain an input into a square root computational operation;
performing a plurality of iterations of a Lucas number sequence associated with a first value and a second value, the first value initiated using the input into the square root computational operation and a first inverse value, wherein an individual iteration of the plurality of iterations comprises at least:
updating one of the first value or the second value based on each of the first value and the second value;
detecting that one of the first value or the second value is zero;
determining an output of the square root computational operation based at least (i) on another one of the second value or the first value and (ii) a second inverse value, wherein the first inverse value and the second inverse value are computed using a batch division operation; and
computing, by the processing device and using the output of the square root computational operation, an output of the cryptographic operation associated with the input into the cryptographic operation, wherein the output of the cryptographic operation comprises at least one of:
a digital signature for the input into the cryptographic operation,
an encryption of the input into the cryptographic operation, or
a decryption of the input into the cryptographic operation.
